(19) United States
(12) Patent Application Publication
(10) Pub. No.: US 2002/0153384 A1
(43) Pub. Date: Oct. 24, 2002

(54) Flag tower and flag tower-plus dispensers for post-it flag notes and printed flags

(76) Inventor: Cecil M. Cooper, Ft. Worth, TX (US)

Correspondence Address: CECIL M. COOPER, 4271 CADIZ DRIVE, FT. WORTH, TX, 76133, US

(21) Appl. No.: 10/074,919

(22) Filed: Feb. 14, 2002

Related U.S. Application Data
(60) Provisional application No. 60/271,230, filed on Feb. 26, 2001.

(51) Int. Cl. G07F 11/00; B65H 1/00

(52) U.S. Cl. 221/34

(57) ABSTRACT

A desk type dispenser for dispensing 3M Post-it® Flag Note Sheets and 3M Post-it® Brand Printed Flags. The Post-it® Flag note sheets are encased in a Post-it® Flag note assembly. Each note sheet in the assembly stack has a narrow band of adhesive coating on one side. The sheets are stacked with the band of adhesive alternating at opposite ends of each adjacent note sheet. The desk type dispenser is a single body member with a removable side panel for ingress/egress of Flag note sheet assemblies. The dispenser body is preferably weighted and has multiple dispensing openings and a storage compartment for one note sheet assembly. Each dispensable Post-it® Flag note assembly is secured in a compartment to restrict movement while an individual note is removed from its assembly. A Post-it® Flag note sheet can easily be removed from the dispenser with one hand.

### CROSS-REFERENCE TO RELATED APPLICATIONS

This application is a continuation-in-part to the U.S. provisional Patent Application No. 60/271,230 granted to Cecil M. Cooper on Feb. 26, 2001.

### BACKGROUND OF THE INVENTION

This invention relates to a dispenser for dispensing individual 3M Post-it® Flag note sheets and 3M Post-it® Brand Printed Flags from an assembly, in one respect, to model # C4211 Designer Tape Flag Dispenser” made by the 3M Company.

The present invention(s) provides numerous improvements over the previously mentioned 3M Company dispenser. The present 3M Company dispenser can dispense a maximum of two (2) Post-it® Flag assemblies. The present invention(s) can dispense a maximum of three (3) for the Flag-Tower and five (5) for the Flag-Tower Plus Post-it® Flag note sheet assemblies. Both present inventions provide a storage compartment for one (1) Post-it® Flag note sheet assembly. Design drawings for the Flag-Tower and Flag-Tower Plus dispensers are presented in this document.

From this point forward, any reference to Post-it® Flag note sheets and assemblies will also include 3M Post-it® Brand Printed Flags.

### BRIEF DESCRIPTION OF THE SEVERAL VIEWS OF THE DRAWINGS

The present inventions will be further described with reference to the accompanying drawing herein:

FIG. 1 is an orthogonal view of the dispenser and panel insert for the dispenser in FIG. 1 (Flag Tower Dispenser);

FIG. 2 is a top plan view of the dispenser of the present invention (Flag Tower Dispenser);

FIG. 3 is a side view of the dispenser in FIG. 1 (Flag Tower Dispenser);

FIG. 4 is an orthogonal view of the dispenser and panel insert for an alternate dispenser design from the present invention the dispenser in FIG. 4 (Flag Tower-Plus Dispenser).

FIG. 5 is a top plan view of the dispenser in FIG. 4 (Flag Tower-Plus Dispenser);

FIG. 6 is a side view of the dispenser in FIG. 4 (Flag Tower-Plus Dispenser).

### BRIEF SUMMARY OF THE INVENTION

The present invention is directed to a dispenser for Post-it® Flag note sheets. The Flag note sheets are independently dispensed from a Post-it® Flag note assembly. Each Post-it® Flag note sheet in the stack has a narrow band of adhesive coating on one side. The sheets are stacked with the band of adhesive alternating at opposite ends of each adjacent note sheet. The dispenser comprises a body with a removable side panel. The side panel allows ingress/egress of Flag note sheet assemblies. The base provides secure compartments for each dispensable Flag note to restrict movement while an individual Flag note sheet is being removed. The dispenser has sufficient weight such that the dispensing action does not tend to lift or move the base position. The invention is designed to use plastic for body material makeup.

### DETAILED DESCRIPTION OF THE INVENTION

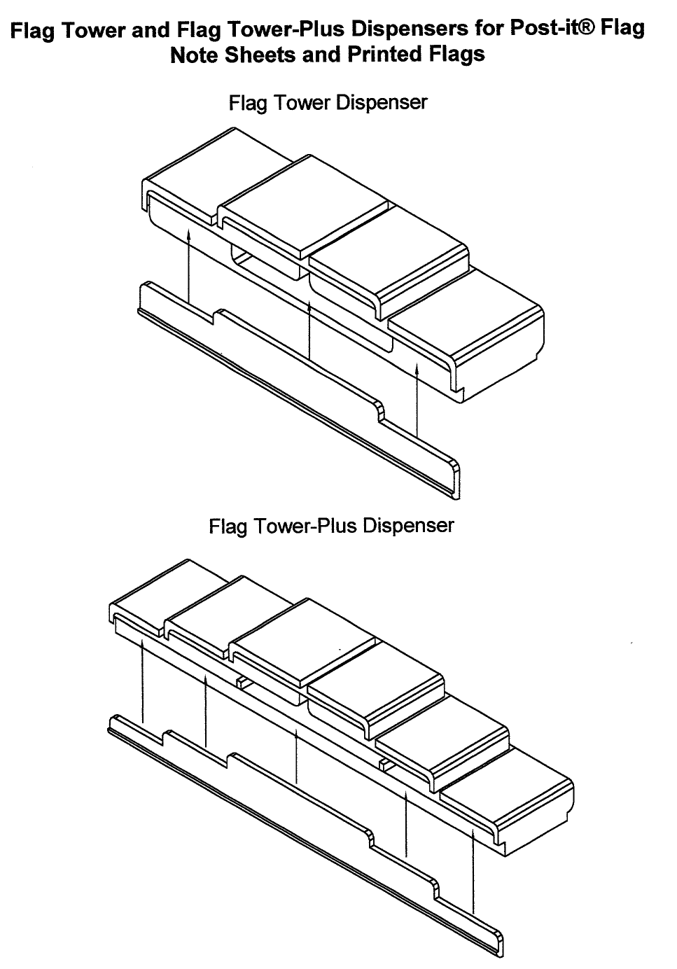

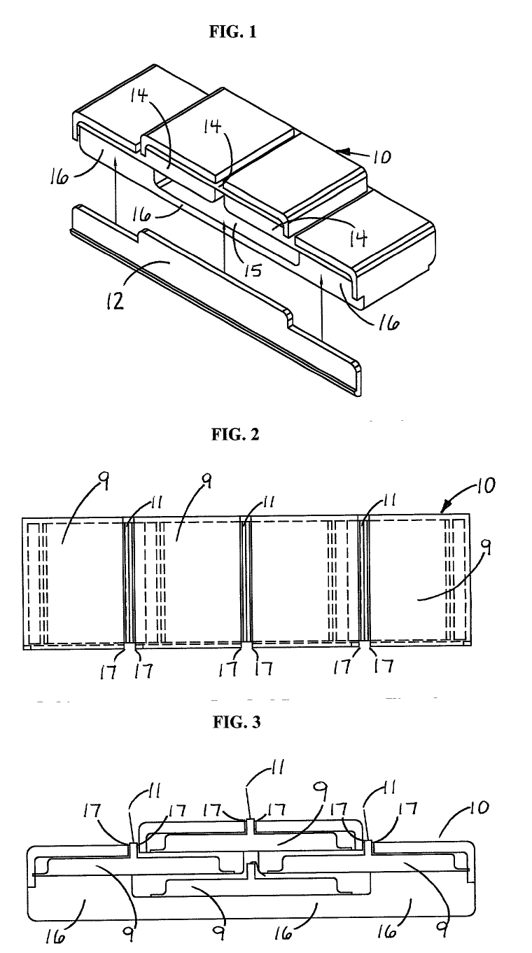

Referring now to FIGS. 1, 2, and 3, there is disclosed a dispenser 10 for Post-it® Flag note assemblies 9 that dispense Post-it® Flag notes 11. Post-it® Flag note assemblies 9 contain a stack of individual Post-it® Flag note sheets 11. Each note sheet in the stack has a narrow band of adhesive coating on one side. The sheets 11 are stacked with the band of adhesive alternating at opposite ends of each adjacent note sheet. The dispenser comprises a main body 10 with a removable panel 12 (FIG. 1 shown without Post-it® Flag note assemblies 9 for clarity). The panel 12 (FIG. 1) allows ingress/egress of the Flag note assemblies 9. After ingress/egress of the Flag note assemblies 9 the panel 12 is slid vertically into the side of the base 10 to secure the dispenser unit 10. The body 10 has additional weight added to internal compartments 16 of the lower portion of the body. This additional weight is in the form of weighted beads that supply sufficient weight to counteract the forces applied during dispensing action of Flag notes 11. This dispenser is preferably formed to have a weight between 16 ounces and 24 ounces. The result is a dispenser that remains in place and stable while Flag notes are dispensed.

### DETAILED DESCRIPTION OF THE INVENTION (CONTINUED)

As shown in FIG. 1, the body 10 is sectioned into four compartments for ease of dispensing Flag notes 11. FIG. 2 presents a top view of the dispenser body 10. Flag notes 11 are only dispensed through the top surface of the dispenser 10. The dispensing openings are defined by opposing edges 17. FIG. 3 shows how the Post-it® Flag assemblies 9 fit compactly into defined compartments. Three compartments are specifically dedicated to dispensing Flag notes 14 (FIG. 1) while one compartment is designed for storage of one Flag note assembly 15 (FIG. 1). This dispenser 10 can dispense a maximum of three Flag note assemblies 9. Initial design results show a base footprint of only 10.5 square inches.

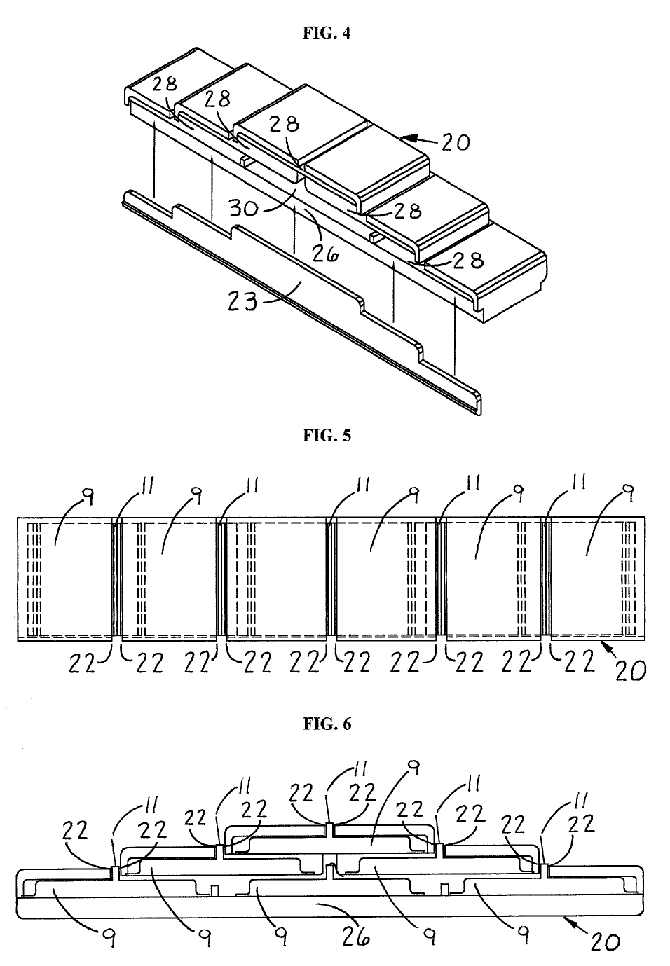

Referring now to the embodiment of FIGS. 4, 5 and 6, it will be noted that the configuration differs from those in the previous figures. This dispenser design allows a larger number of Post-it® Flag assemblies to be dispensed. The larger capacity is achieved by extending the length but keeping height and width the same as the previously mentioned design.

The dispenser comprises a main body 20 with a removable panel 23 (FIG. 4 shown without Post-it® Flag note assemblies 9 for clarity). The panel 23 allows ingress/egress of the Flag note assemblies 9. After ingress/egress of the Flag note assemblies 9 the panel is slid vertically into the side of the base 20 to secure the dispenser unit 20. The body 20 has additional weight added to an internal compartment 26 of the lower portion of the body 20. This additional weight is produced from weighted beads that supply sufficient weight to counteract the forces applied during the manual dispensing action of Flag notes 11. This dispenser is preferably formed to have a weight between 16 ounces and 24 ounces.

As defined in FIG. 4, the body 20 is sectioned into six compartments for ease of dispensing Flag notes 11. Five compartments are specifically dedicated to dispensing Flag notes 28 while one compartment is designed for storage of one Flag note assembly 30. FIG. 5 shows atop view of the dispenser body 20. Flag notes 11 are only dispensed through the top surface of the dispenser 20. The dispensing openings are defined by opposing edges 22. FIG. 6 shows how the Post-it® Flag assemblies 9 fit compactly into defined compartments. This dispenser 20 can dispense a maximum of five Flag note assemblies 9. Initial design results show a base footprint of only 15.75 square inches.

### STATEMENT REGARDING FEDERALLY SPONSORED RESEARCH OR DEVELOPMENT

Not Applicable.

### REFERENCE TO SEQUENCE LISTING, A TABLE, OR COMPUTER PROGRAM LISTING COMPACT DISC APPENDIX

Not Applicable.

1. I claim a pyramid shaped, multi-unit dispenser for 3M Post-it® flag notes and printed flags (called the flag tower and flag tower-plus dispensers for 3M post-it(p flag notes and printed flags).

2. These items are identified as desk type manual dispensers for 3M Post-it® Brand Flag Note sheets and 3M Post-it® Brand Printed Flags.

3. The scope of my claim covers any type of multiple dispenser for 3M Post-it® Brand Flag Note sheets and 3M Post-it® Brand Printed Flags.
